(19) United States
(12) Patent Application Publication
(10) Pub. No.: US 2010/0306014 A1
(43) Pub. Date: Dec. 2, 2010

(54) UTILITY SERVICE COMPONENT RELIABILITY AND MANAGEMENT

(75) Inventor: Maggie Chow, Hartsdale, NY (US)

Correspondence Address: CANTOR COLBURN LLP, 20 Church Street, 22nd Floor, Hartford, CT, 06103, US

(73) Assignee: CONSOLIDATED EDISON COMPANY, New York, NY (US)

(21) Appl. No.: 12/791,363

(22) Filed: Jun. 1, 2010

Related U.S. Application Data
(60) Provisional application No. 61/182,993, filed on Jun. 1, 2009.

(51) Int. Cl. G06Q 10/00; G06Q 50/00; G06F 15/18

(52) U.S. Cl. 705/8; 705/7; 706/12

(57) ABSTRACT

A computer-implemented method and system performing allocating capital assets for managing a plurality of utility service components. The method includes ranking each of the utility service components based on data retrieved corresponding to the utility service components, calculating a base failure metric for each of the utility service components, receiving a selection of at least one utility service component of the plurality of utility service components inputted by a user, analyzing the selected utility service component under a plurality of improvement scenarios, calculating an estimated failure metric of the selected utility service component based on each of the improvement scenarios, and displaying comparison information between the base failure metric and the estimated failure metric.

This application claims the benefit of U.S. Provisional Patent Application No. 61/182,993 filed on Jun. 1, 2009, which is incorporated by reference herein in its entirety.

### BACKGROUND OF THE INVENTION

The present invention relates generally to a method and system for assisting in the allocation of resources in the upgrading of capital assets, and in particular to a system for comparing different upgrade (i.e., improvement) scenarios of utility capital assets.

Electrical power is typically produced at centralized power production facilities and transferred at high voltages to local substations. The local substations transform the electrical power into a medium or low voltage. The electrical power is subsequently distributed through feeder circuits to local customers. The power is thus delivered to an end customer that consumes the electrical power.

Feeder circuits may be comprised of a number of different components, such as cables for example, that were installed at different periods of time as the circuit was expanded, upgraded or repaired. In the case of electrical cables, the original circuit wiring was a paper insulated lead cable (PILC). While PILC performed satisfactorily, in some cases for over 40 years, utilities desired a more robust cable that allowed for higher ratings due to increasing demands on the electrical grid. Over time, new insulation types, such as cross-linked polyethylene (XLP) and ethylene propylene rubber (EPR) for example, were developed to improve the performance, reliability and life expectancy of electrical power conductors. Thus, in a large urban environment, a single feeder may have three different types of cable.

Each year, electrical utilities allocate considerable portions of their operating budgets to upgrade cabling in feeder circuits. Typically, each feeder circuit is ranked based on a risk score according to past performance, and an amount of electrical overload of which the circuit is subjected. The feeder circuits with the lowest rank are addressed first, where one is the worst and 1000, for example, is the best and least likely to fail, and the number of projects completed depends on the amount of resources the utility can commit. It should be appreciated that in large urban and metropolitan areas there are thousands of miles of electrical cables and the cable replacement process is continuous.

It should be appreciated that each of the different types of cable have a different level of reliability based on many factors included cable type, cable age, electrical loading conditions, environmental conditions and the like. Traditionally, the risk ranking of feeder circuits was a long and arduous task. Due to the number of variables involved, the analysis was performed at a high level resulting in a less than optimal distribution of assets in the cable replacement process. Further, while computer methods allowed for modeling of circuits, it was still difficult to compare the needs of different feeders that could be affected by different failure modes.

Accordingly, while existing systems and methods for allocating capital assets for electrical utility networks are suitable for their intended purposes, there still remains a need for improvements particularly regarding the prioritization of upgrades and the distribution of capital assets.

### SUMMARY OF THE INVENTION

According to an embodiment of the present invention, a computer-implemented method of allocating capital assets for managing a plurality of utility service components is provided. The method includes ranking each of the utility service components based on data retrieved corresponding to the utility service components, calculating a base failure metric for each of the utility service components, receiving a selection of at least one utility service component of the plurality of utility service components inputted by a user and analyzing the selected utility service component under a plurality of improvement scenarios. The method further includes calculating an estimated failure metric of the selected utility service component based on each of the improvement scenarios and displaying comparison information between the base failure metric and the estimated failure metric.

A computer readable storage medium and a system performing the method mentioned above are also provided.

### BRIEF DESCRIPTION OF THE DRAWINGS

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1 is a block diagram illustrating a system for capital asset allocation for managing a plurality of utility service components that can be implemented within embodiments of the present invention.

FIG. 2 is a block diagram illustration of a method of allocating capital assets that can be implemented within embodiments of the present invention.

FIG. 3 is a tree diagram illustration of electrical feeder attributes for determining electrical feeder circuit susceptibility that can be implemented within embodiments of the present invention.

FIG. 4 is a tree diagram illustration cable attributes that can be implemented within embodiments of the present invention.

FIG. 5 is a tree diagram illustrating joint attributes that can be implemented within embodiments of the present invention.

FIG. 6 is an illustration of a feeder selection screenshot that can be implemented within embodiments of the present invention.

FIG. 7 is an illustration of a graphical representation of an electrical feeder circuit that can be implemented within embodiments of the present invention.

FIG. 8 is another illustration of a graphical representation of electrical feeder circuits that can be implemented within embodiments of the present invention.

FIG. 9 is an illustration of a graphical representation of a portion of a feeder circuit that can be implemented within embodiments of the present invention.

FIG. 10 is a screenshot illustrating an improvement scenario that can be implemented within embodiments of the present invention.

FIG. 11 is a diagram illustrating the performance of comparison between base failure metric and estimated failure metric based on the improvement scenario shown in FIG. 9 that can be implemented within embodiments of the present invention.

FIG. 12 is a screenshot illustrating a feeder circuit portfolio that can be implemented within embodiments of the present invention.

FIG. 13 is screenshot illustrating another improvement scenario that can be implemented within embodiments of the present invention

FIG. 14 is a screenshot illustrating another improvement scenario that can be implemented within embodiments of the present invention.

FIG. 15 is a diagram illustrating the performance of comparison between base failure metric and estimated failure metric based on the improvement scenario shown in FIG. 14 that can be implemented within embodiments of the present invention.

FIG. 16 is a screenshot illustrating another improvement scenario that can be implemented within embodiments of the present invention.

FIG. 17 is a diagram illustrating the performance of comparison between base failure metric and estimated failure metric based on the improvement scenario shown in FIG. 16 that can be implemented within embodiments of the present invention.

FIG. 18 is a screenshot illustrating another improvement scenario that can be implemented within embodiments of the present invention.

FIG. 19 is a diagram illustrating the performance of comparison between base failure metric and estimated failure metric based on the improvement scenario shown in FIG. 18 that can be implemented within embodiments of the present invention.

FIG. 20 is a screenshot illustrating another improvement scenario that can be implemented within embodiments of the present invention.

FIG. 21 is a diagram illustrating the performance of comparison between base failure metric and estimated failure metric based on the improvement scenario shown in FIG. 20 that can be implemented within embodiments of the present invention

FIG. 22 is an illustration of a capital asset prioritization screenshot that can be implemented within embodiments of the present invention.

The detailed description explains embodiments of the invention, together with advantages and features, by way of example with reference to the drawings.

### DETAILED DESCRIPTION

The present invention provides a method and system performing the method of allocating capital assets for managing a plurality of utility service components. According to an embodiment of the present invention, a system 100 is provided. The system 100 provides a computerized way to strategically plan and manage improvements to be performed on a plurality of utility service components. The plurality of utility service components may include for example, electrical feeder circuits of an electricity service network however the present invention is not limited hereto and may vary as necessary. The present invention will be discussed in relation to electrical feeder circuits of an electricity utility service network, for example. The present invention provides the advantages of being able to simulate the value of different work on an electrical feeder circuit and consider feeder load, feeder attributes, and cost in a single integrated system.

According to an embodiment of the present invention, the system 100 includes a plurality of databases 10 which receives raw asset data from a plurality of source data originators 15. According to an embodiment of the present invention, the raw asset data may include data corresponding to the plurality of utility service components of the system 100 such as statistical data. This information is fed into the plurality of databases 10 which include for example, a Feeder susceptibility database, Feeder statistics database, a mapping database such as Google® Assets containing geo-spatial data, a main program database (i.e., EdisonML), a Rankings database, and a Cable runs database, for example. A machine learning model 20 is employed within the system 100 to calculate rankings of the utility service components based on ranking information such as cable and joint rankings and feeder susceptibility ranking and scores. This information is created and may be stored in the Rankings database discussed above. Processed data is transferred between the machine learning model 20 and the databases 10. The machine learning model 20 may incorporate machine learning and pattern recognition algorithms to assist in analysis of data, such as that described in co-pending, commonly assigned U.S. patent application Ser. No. 12/178,553 entitled System and Method for Grading Electricity Distribution Network Feeders Susceptible to Impending Failure filed on Jul. 23, 2008 by Arthur Kressner, Mark Mastrocinque, Matthew Koenig and John Johnson which is incorporated by reference in its entirety.

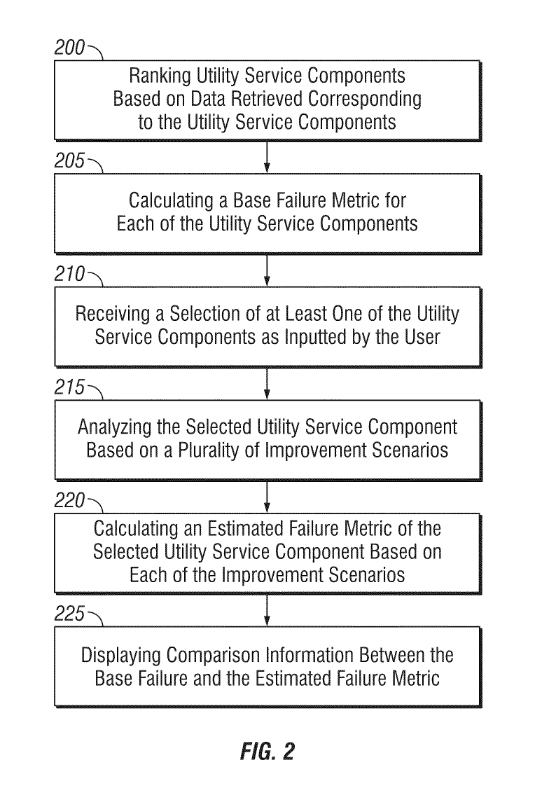

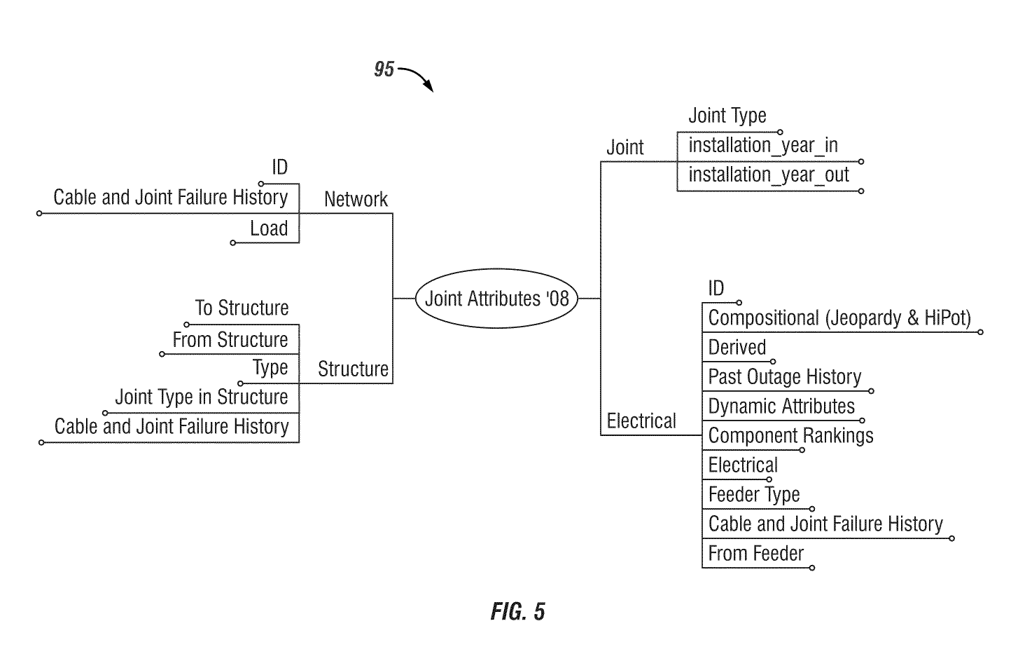

According to an embodiment of the present invention, the system 100 further includes a re-ranking subsystem 30 which updates the databases 10 based on electrical component changes as selected by a user 1 of the system 100. The system 100 further includes a visualization subsystem 40 which displays graphical information to the user pertaining to the utility service components. The graphical information may be three-dimensional (3-D) information provided by Google Earth®, for example. As shown in FIG. 5 to be discussed in more detail below. The system 100 further includes a Cable Runs subsystem 50 which provides cable run information to the cable runs database. The cable run information may include, for example, a long run of a section of a specific cable type such as PILC cables without introducing stop joints, when determining an improvement strategy using the system 100. The system 100 also includes a graphical user interface (GUI) 60 such as a computer display, to display visual information from the visualization subsystem 40 and other information pertaining to the system 100 to the user 1. Additional details concerning the system 100 and a method for allocating capital assets for managing a plurality of utility service components via the system 100 will now be discussed below with reference to FIGS. 2 through 22.

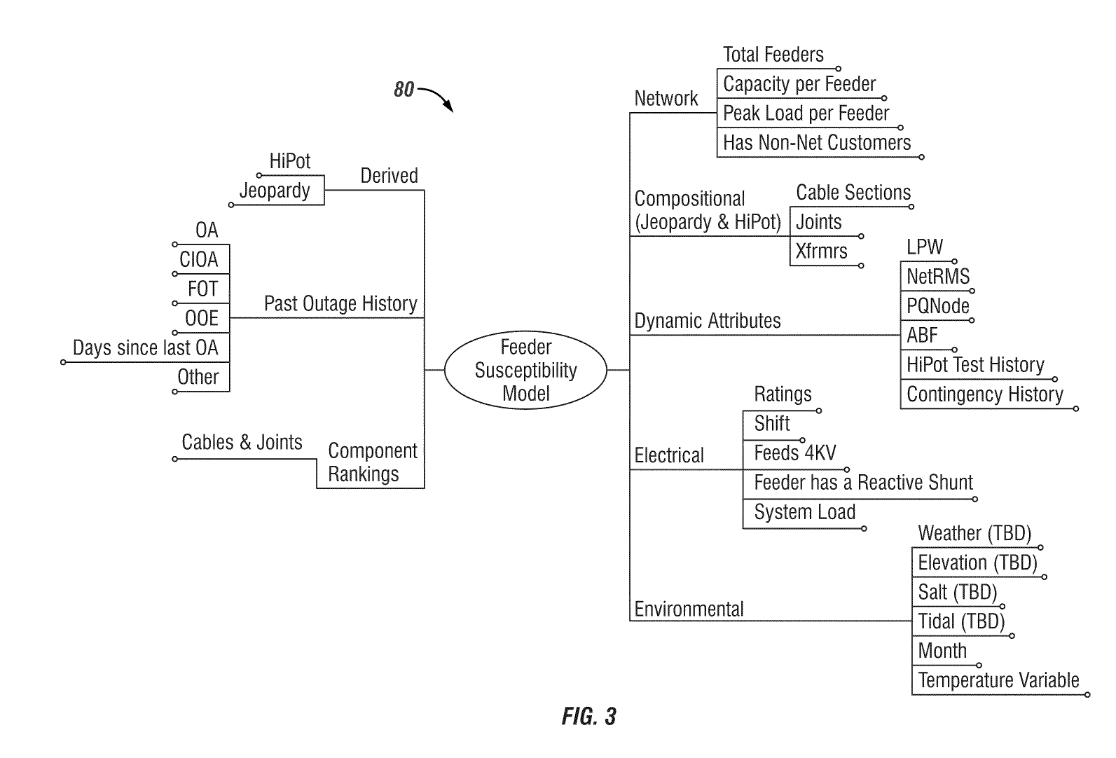

FIG. 2 is a flowchart illustrating a method for allocating capital assets for managing a plurality of utility service components. Additional details concerning various operations of the method will be discussed while referencing FIGS. 3 through 12. As shown in FIG. 2, at operation 200, each of the utility service components are ranked based on data retrieved corresponding to the utility service components as shown in FIGS. 3 through 5.

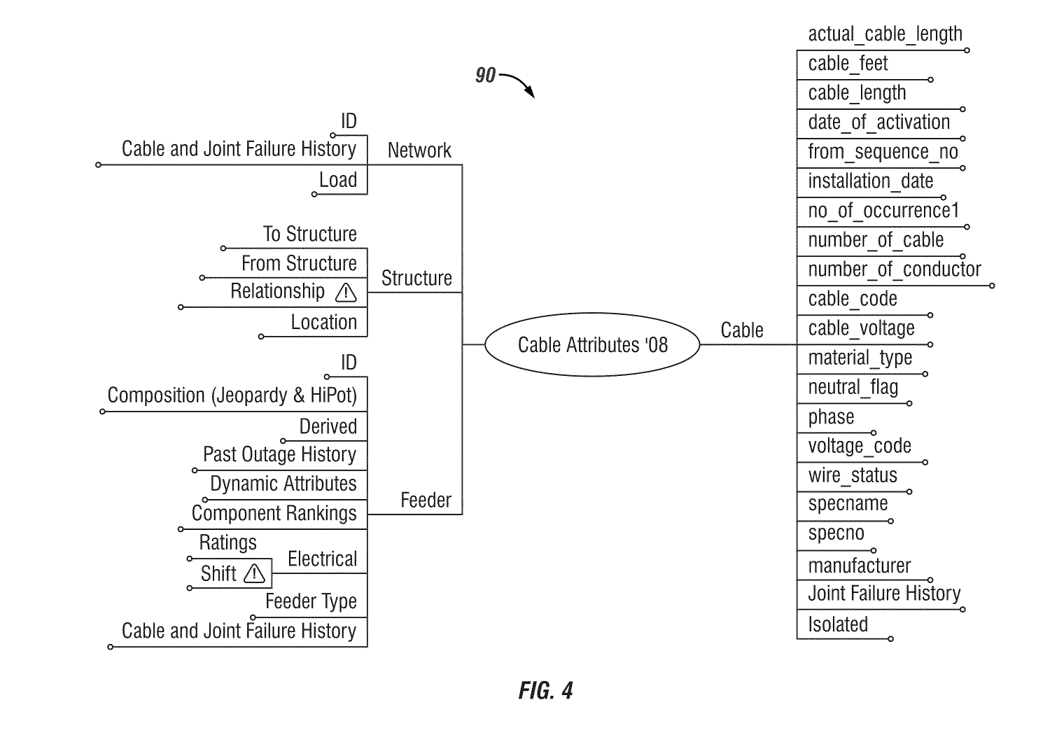

FIG. 3 is a diagram illustrating attributes of an electrical feeder circuit that can be implemented within embodiments of the present invention. As shown in FIG. 3, the data retrieved includes attributes 80 of an electrical feeder circuit which may include at least one of derived information, past outage history, component rankings, network configuration, compositional characteristics, dynamic attributes, electrical characteristics and environmental characteristics. The derived information may be from existing databases. The past outage history may include, for example, feeder outage (OA) information, cut in open auto information (CIOA), failed on test (FOT), of on emergency (OOE), and days since last outage. The component characteristics may include cables and joints information. The network configuration may include information regarding total electrical feeder circuits, capacity per feeder circuit, peak load per feeder circuit, and whether the network include non-network customers. The compositional characteristics may include information regarding cable sections, joints, and transformers. The dynamic attributes may include, for example, information regarding load pocket weight (LPW), remote monitoring system (NetRMS), power quality (PQ) Node, ABF, HiPot Test history which is an electrical potential test for checking the integrity of insulation, and contingency history. The electrical characteristics may include information regarding ratings, shift, feed range, and system load and the environmental characteristics may include information such as weather, elevation, salt, tidal, month and temperature variable. FIG. 4 is a diagram illustrating component characteristics of an electrical feeder circuit that can be implemented within embodiments of the present invention. As shown in FIG. 4, the component characteristics may include cable attributes 90 that include at least one of network information, structure information, feeder information and specific cable information. The network information may include for example, ID information, cable and joint failure history and load information. The structure information may include the structure to and from which the cable is providing service, the relationship between the structures and the location of the structures. The feeder information may include for example, compositional information, derived information, past outage information, dynamic attributes, electrical information, feeder type, and cable and joint failure history. The cable information may include for example, cable length and type, installation information including date, number of cables, cable voltage information, phase information and manufacturer information. FIG. 5 is a diagram illustrating joint attributes 95 of an electrical feeder circuit that can be implemented within embodiments of the present invention. As shown in FIG. 5, the joint attributes 95 may include network characteristics, structure characteristics, joint characteristics and feeder characteristics. The network characteristics may include ID information, cable and joint failure history and load information. The structure characteristics may include information regarding the structures to and from which the joint is connected, the type of structure, the joint type within the structure and additional cable and joint failure history information. The joint characteristics may include joint type, installation year ‘in’ and ‘out’ information. Further, the feeder characteristics may include ID information, compositional information, derived information, past outage history information, dynamic attributes information, component ranking information, electrical information, feeder type information, additional cable and joint failure history information and from which feeder information.

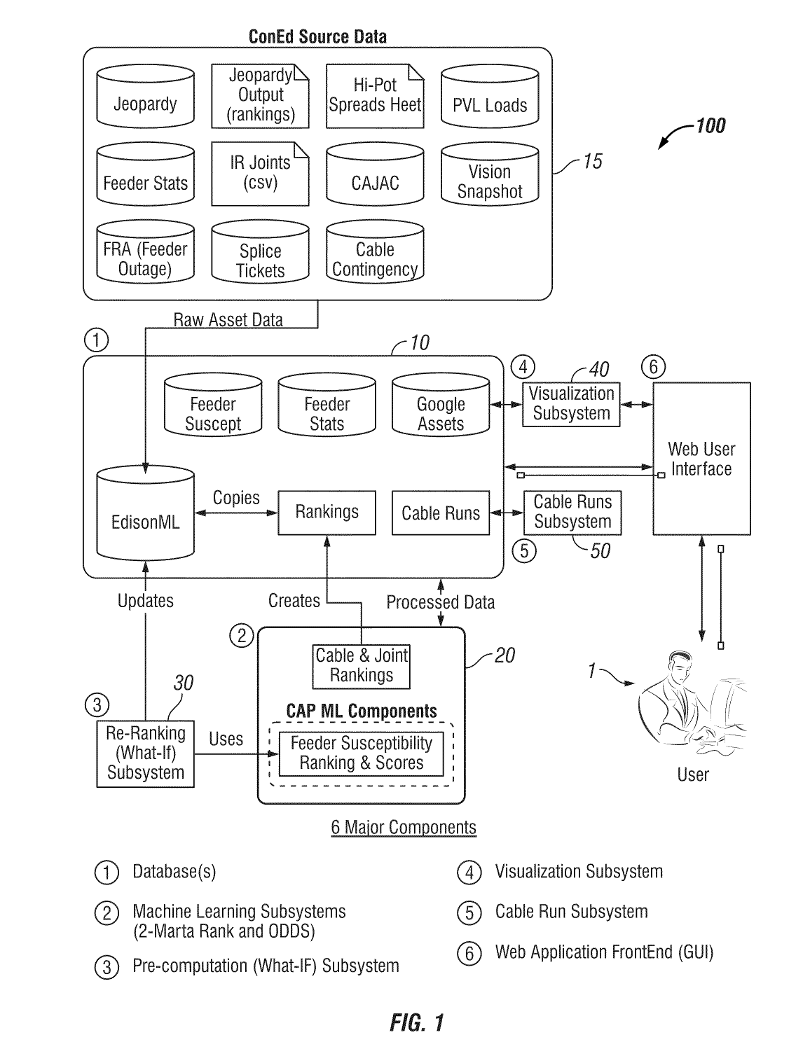

From operation 200, the process moves to operation 205, where a base failure metric is calculated for each of the utility service components. According to an embodiment of the present invention, the base failure metric is mean-time-between-failure (MTBF) which is a metric to measure the average time between failures of the utility service components. According to an embodiment of the present invention, ranking each of the utility service components and calculating a base failure metric are performed via the machine learning model 20 as shown in FIG. 1, for example. The utility service components are ranked together where the rankings are in the order of worst to best and least likely to fail. As improvements are made to the utility service components, the rankings are updated to reflect any replacements made, via the re-ranking subsystem 30 shown in FIG. 1.

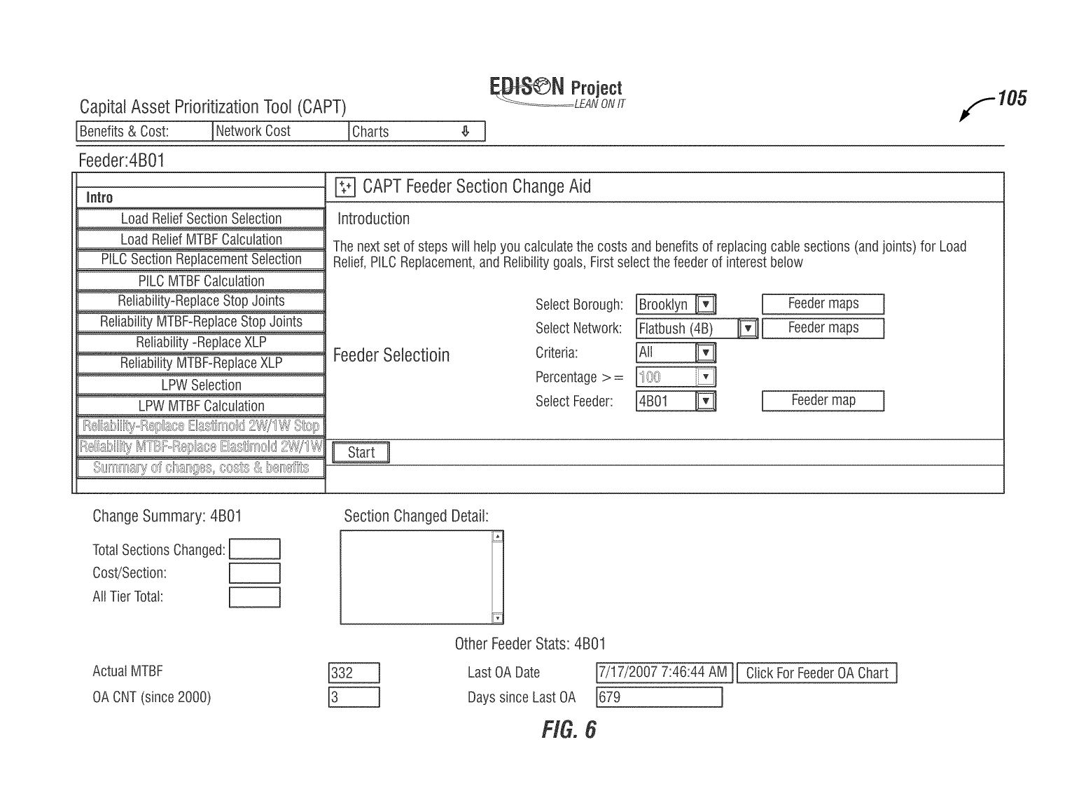

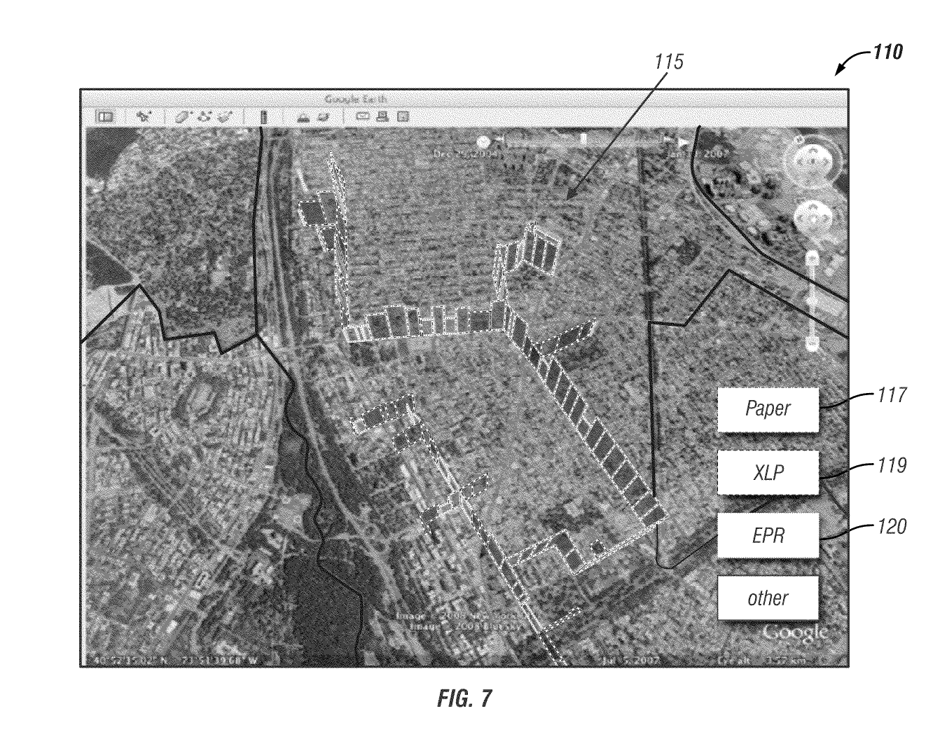

FIG. 6 is an illustration of a feeder selection screen 105 displayed via the GUI 60 of FIG. 1 that can be implemented within embodiments of the present invention. As shown here in the top left corner of the screen 105, the user 1 is able to select to view Benefits and Cost, Network Cost or Charts, for example. In FIG. 6, the user 1 is able to select to view feeder maps in order to select at least one utility service component of interest. For example, the user 1 may view a list of feeder circuits and/or actual maps of the respective feeder circuits. Referring back to FIG. 2, from operation 205, the process moves to operation 210, when the user 1 selects to view feeder maps, the plurality of utility service components are displayed in a graphical representation to be viewed by the user, for example, in a map as shown in FIGS. 7 through 9. FIG. 7 is an illustration of a graphical representation of an electrical feeder circuit that can be implemented within embodiments of the present invention.

In FIG. 7, a three-dimensional graphical representation 110 is provided having a geographical map provided by Google Earth®, for example, with a utility service component (i.e., an electrical feeder circuit 115) overlay. As shown in FIG. 5, the electrical feeder circuit 115 includes a plurality of segments 117, 119 and 120. According to an embodiment of the present invention, each of the plurality of segments 117, 119 and 120 of each of the plurality of utility service components are represented by different colors, for example, on the graphical representation 110. As shown in FIG. 5, the segments 117, 119 and 120 are PILC sections, XLP sections, and EPR sections, respectively of the electrical feeder circuit 115. Further, according to an embodiment of the present invention, the height of each segment 117, 119 and 120 represents a risk level of each segment 117, 119 and 120. For example, as shown in FIG. 7, all of the EPR sections 120 are of a height shorter than the PILC sections 117 and the XLP sections 119 which indicates that the risk level of the EPR sections 120 is less than that of the PILC sections 117 and the XLP sections 119.

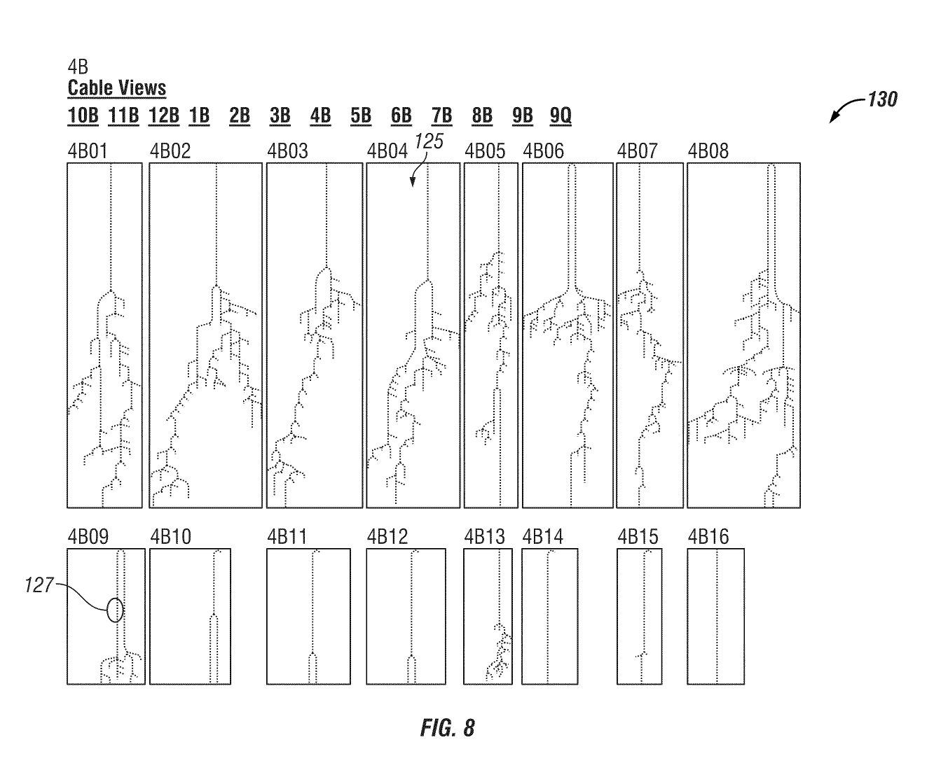

FIG. 8 is an illustration of another graphical representation of an electrical feeder circuit that can be implemented within embodiments of the present invention. As shown in FIG. 8, each utility service component (i.e., electrical feeder circuit 125) is graphically displayed in a two-dimensional diagram 130. According to an embodiment of the present invention, a risk level such as an overload condition of each of the segments 117, 119 and 120 of each of the plurality of utility service components are graphically displayed in color, for example (as depicted by the circle 127, for example).

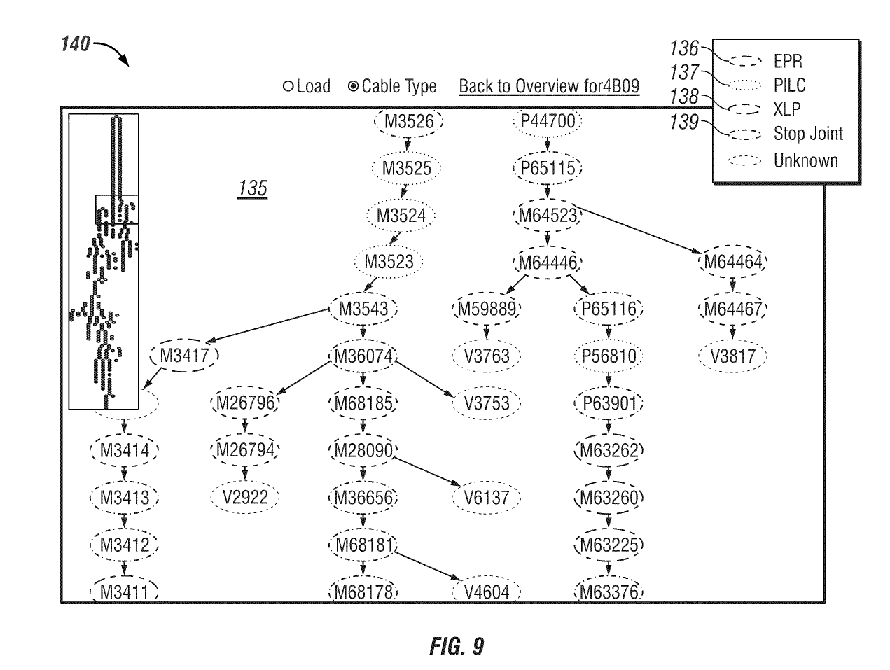

FIG. 9 is an illustration of a graphical representation of a portion of an electrical feeder circuit that can be implemented within embodiments of the present invention. As shown in FIG. 9, the graphical representation 140 provides an exploded view of an electrical feeder circuit 135 including a plurality of segments 136, 137 and 138. These segments 136, 137 and 138 are similar to segments 117, 119 and 120 shown in FIG. 7, for example in that they indicate a type of cable used within the electrical feeder circuit 135. Also shown in the graphical representation 140 of FIG. 7, are additional segments (i.e., stop joints 139) between each of the segments 136, 137 and 138. According to an embodiment of the present invention, this graphical representation 140 may also illustrate overloaded sections, for example, between each of the segments 136 through 139 to be viewed by the user 1 shown in FIG. 1.

Referring back to FIG. 2, upon reviewing at least one of the graphical representations as shown in FIGS. 7 through 9, the system 100 receives a selection of interest of at least one utility service component of the plurality of utility service components as inputted by a user 1 via a screen provided at the GUI 60 as shown in FIG. 6. As shown in FIG. 6, the user 1 is able to select a specific electrical feeder circuit of interest based on a location of the specific electrical feeder circuit including the borough and the electrical network on which it resides, predetermined criteria such as load and a percentage of overload such as 100% overloaded, 105% overloaded or 110% overloaded. The user 1 is then able to select a specific electrical feeder circuit as desired.

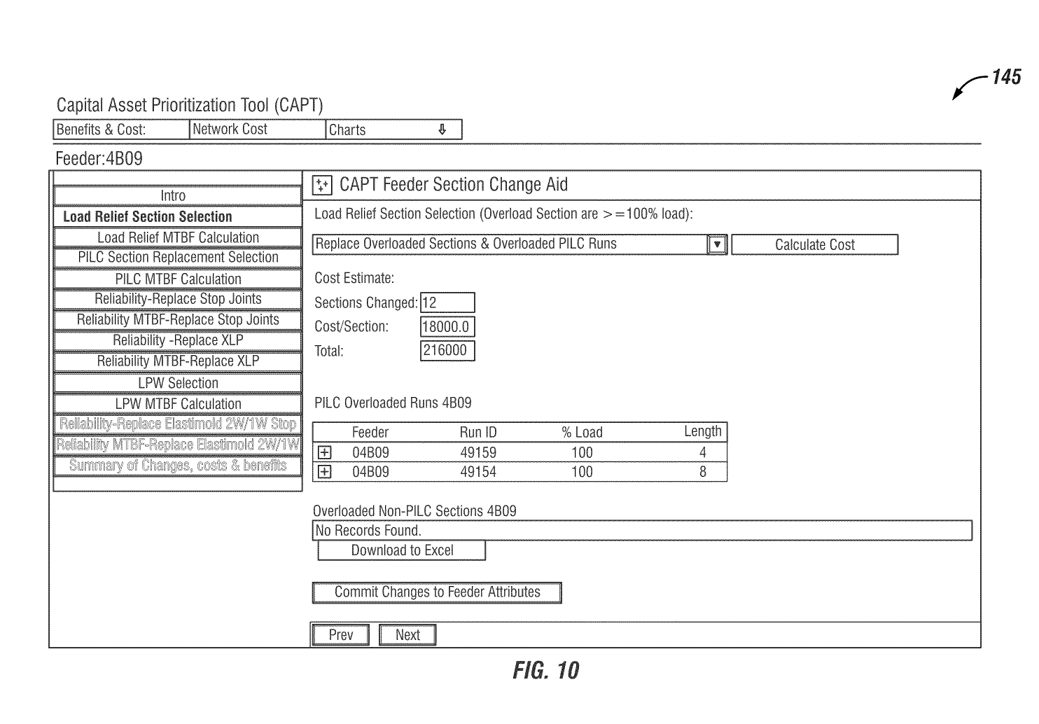

Referring back to FIG. 2, from operation 210, the process moves to operation 215 where the selected utility service component is analyzed under a plurality of improvement scenarios as selected by the user 1. According to an embodiment of the present invention, the improvement scenarios comprise at least one of load relief, segment replacement such as PILC section replacement and XLP replacement and segment reliability such as replacement of stop joints, Elastimold™ stop joints, for example, and XLP sections which will now be discussed below with reference to FIGS. 10 through 20. According to an embodiment of the present invention, the selected utility service component (i.e., an electrical feeder circuit) is analyzed under the plurality of improvement scenarios by displaying the improvement scenarios for the selected utility service component to the user 1, and receiving a selection of one of the improvement scenario from the user 1. For example, as shown in the screenshot 145 of FIG. 10, the user 1 may select an improvement scenario such as load relief section selection. Specifically, if the user 1 selects to replace overloaded sections and overloaded PILC runs. According to an embodiment of the present invention, the system 100 may calculate the cost of improvement based on cost information input by the user or a default cost as predetermined by the system 100. According to an embodiment of the present invention, the system 100 provides a selection of segments of the selected utility service component to be improved including information such as feeder number, Run ID which indicates structure information, load percentage and feeder length, and an associated cost as calculated. For example, as shown in FIG. 10, the system 100 determined that there are 12 PILC sections to be changed at a cost of $18000.00 which would cost approximately $216,000.00 The user 1 is able to download this information to a spreadsheet such as Microsoft Excel™, for example. The user 1 is also able to commit to changing the selected segments of the feeder circuit as provided.

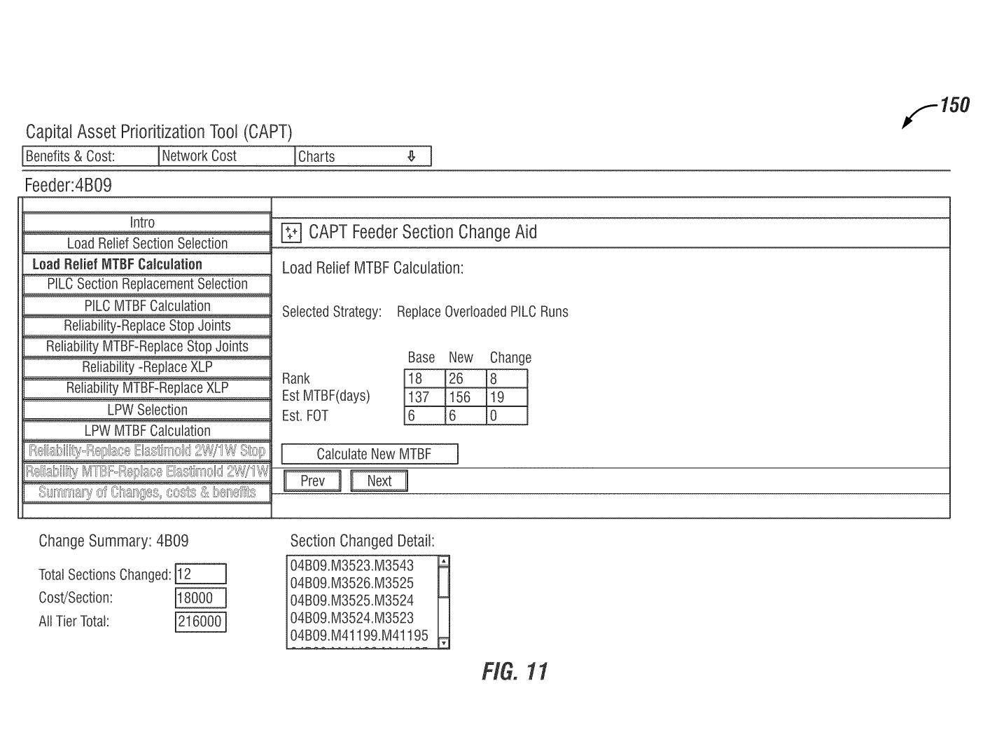

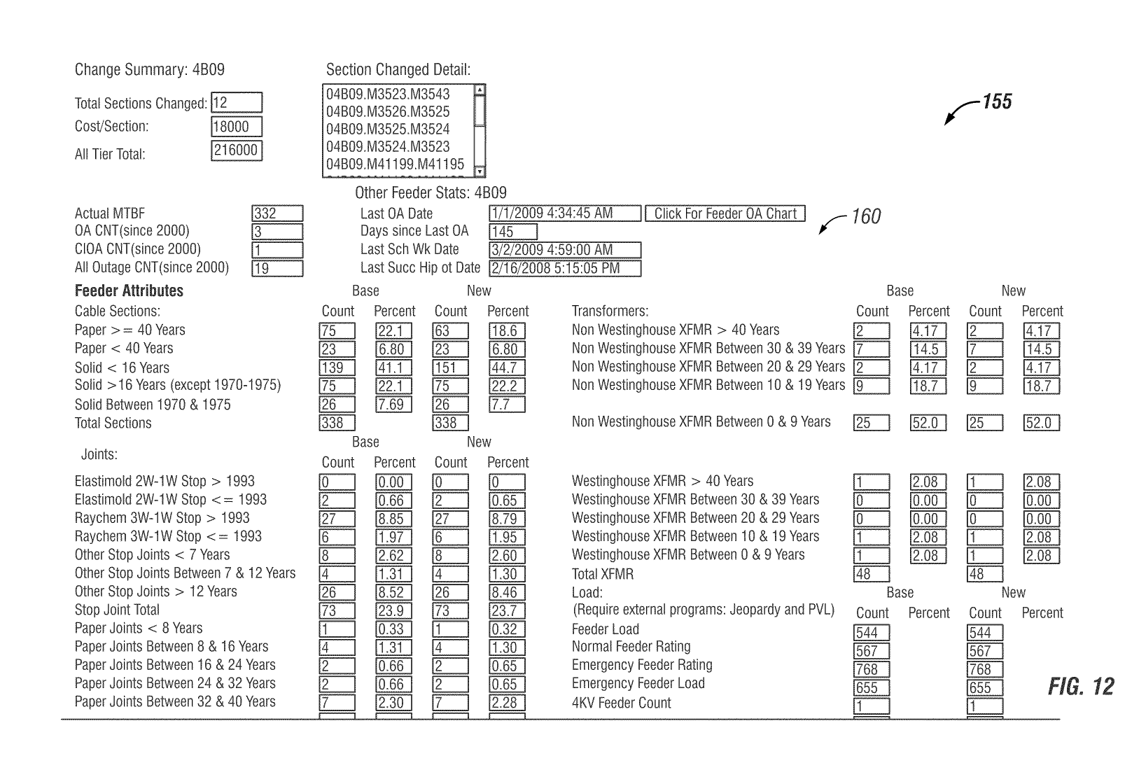

Referring back to FIG. 2, from operation 215, the process moves to operation 220, where an estimated (i.e., new) failure metric of the selected utility service component is calculated based on each of the improvement scenarios. According to an embodiment of the present invention, the estimated failure metric is a cost per MTBF based on the improvement scenario selected by the user. From operation 220, the process moves to operation 225, where comparison information between the base failure metric and the estimated failure metric is displayed to the user via the GUI 60 as shown in FIG. 11. FIG. 11 is a screenshot 150 illustrating the comparison information provided to the user. According to an embodiment of the present invention, the comparison data includes the base MTBF and the estimated MTBF and the difference between them. For example, as shown in the screenshot 150, the system 100 provides a base rank, estimated MTBF and estimated failure on Test (FOT) information along with a new, estimated MTBF, associated rank and FOT, and the difference between them. For example, by changing out the 12 PILC sections, the rank of the selected feeder circuit will increase by 8 and the MTBF will increase by 19. The screenshot 150 also provides additional details regarding the sections to be changed including feeder portfolio information as shown in FIG. 12. FIG. 12 is a screenshot 155 illustrating feeder portfolio information 160 pertaining to the feeder circuit selected by the user 1. The feeder portfolio information 160 includes feeder attributes such as cable sections, joint information, transformer information and load information.

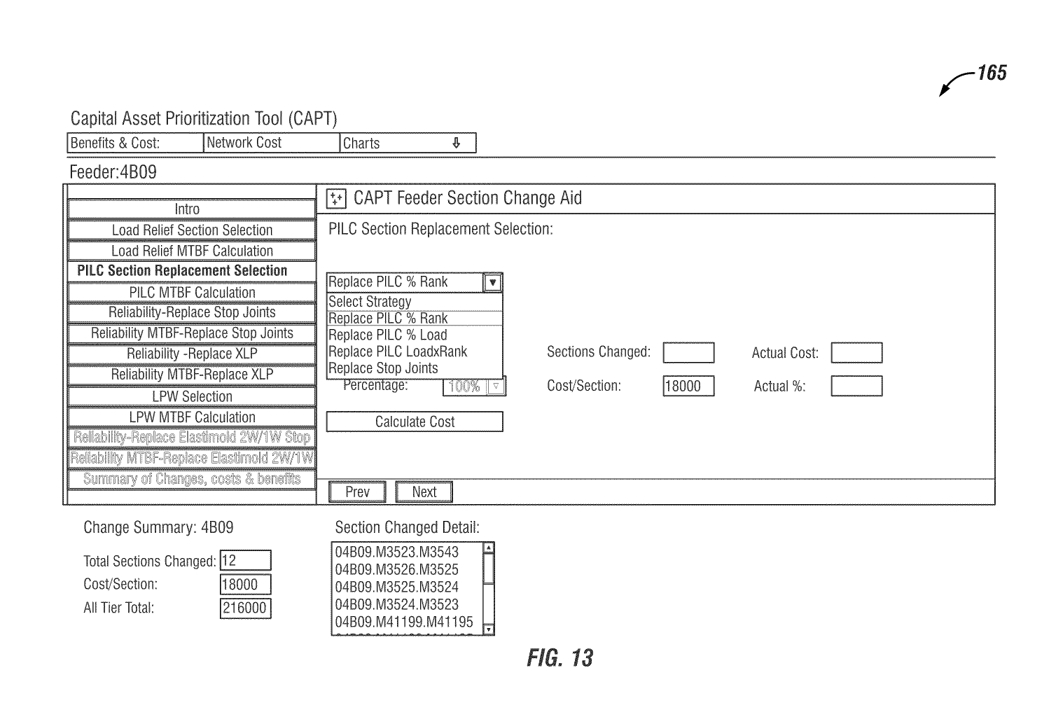

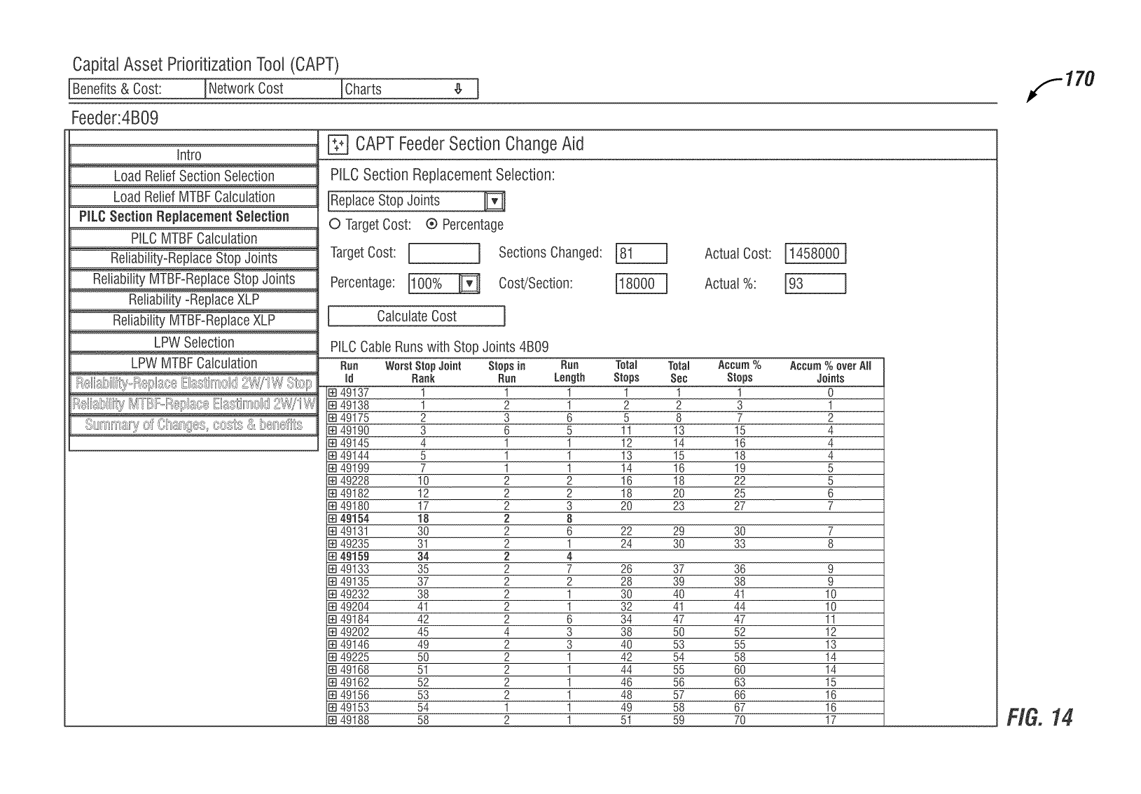

According to another embodiment of the present invention, the user is able to select the segments to be improved based on at least one of a target cost, percentage of segments to be improved, rank of the segment, load of the segment, or load multiplied by the rank as shown in FIG. 13. FIG. 13 is a screenshot 165 which illustrates PILC section replacement selection information. As shown here, the user 1 is able to select from a plurality of improvement scenarios such as replace PILC based on rank, load or load multiplied by the rank, or to replace the stop joints between the segments, for example. The system 100 is also able to calculate cost based on the improvement scenario selected by the user 1. For example, as shown in FIG. 14, a screenshot 170 is provided illustrating another improvement scenario to be implemented within embodiments of the present invention. As shown in FIG. 14, the user 1 may select to replace stop joints. The system 100 then calculates costs based criteria as input by the user 1. That is, the user 1 may select to calculate cost based on target cost or based on a percentage of stop joints to be replaced such as 100%.

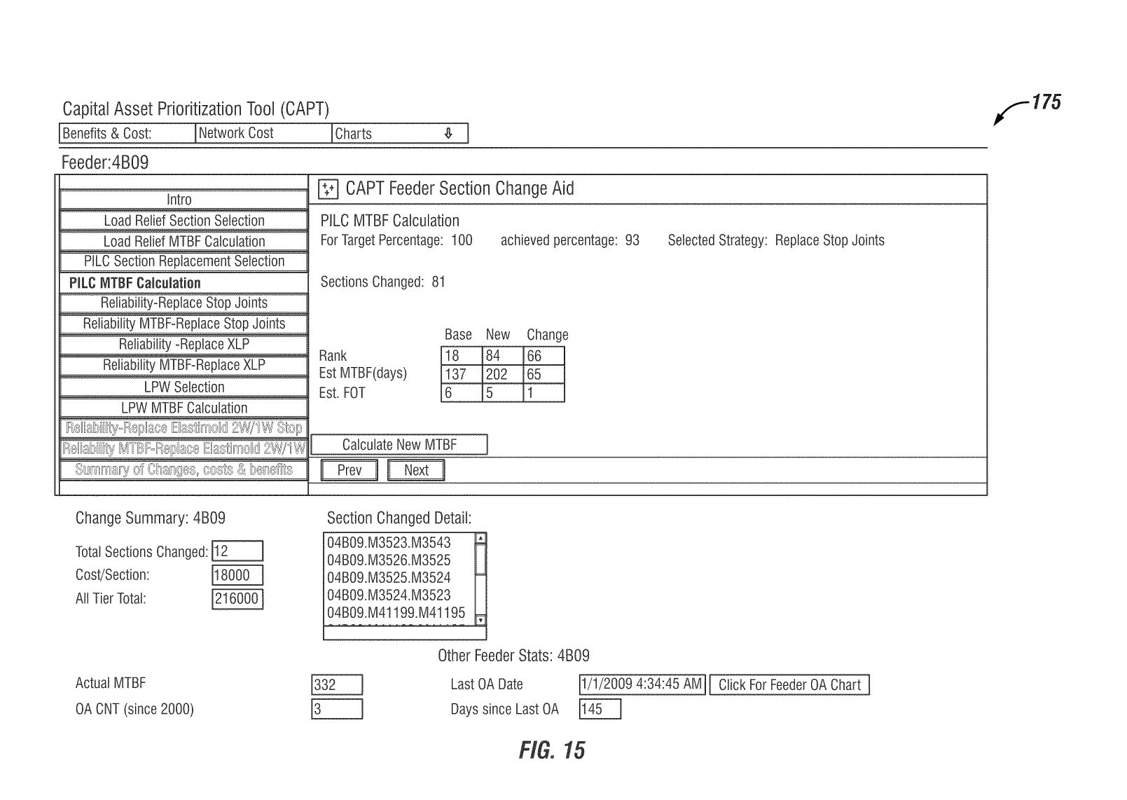

FIG. 15 is a screenshot illustrating the comparison information provided to the user 1 similar to that shown in FIG. 11. However, the comparison information shown in FIG. 15 takes into consideration the replacement of stop joints as selected by the user 1 discussed above with respect to FIG. 14. As shown in the screenshot 175 in FIG. 15, the rank of the selected feeder circuit increases by 66 and the MTBF increases by 65, for example.

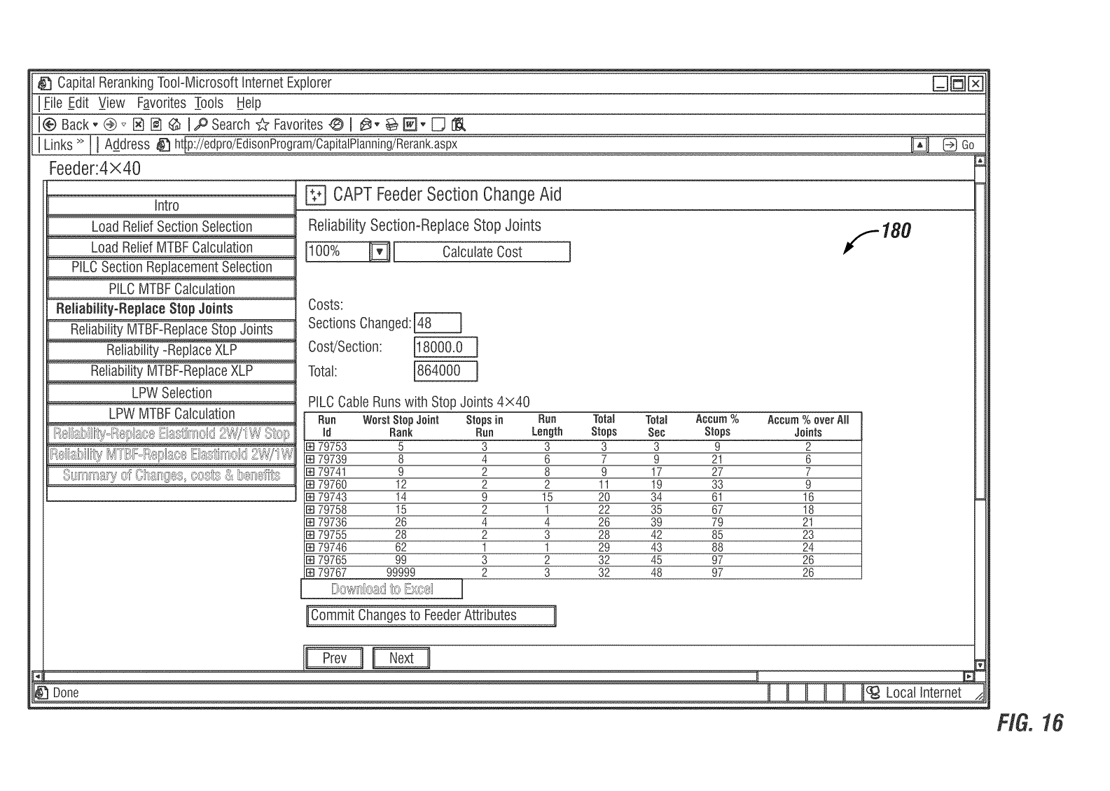

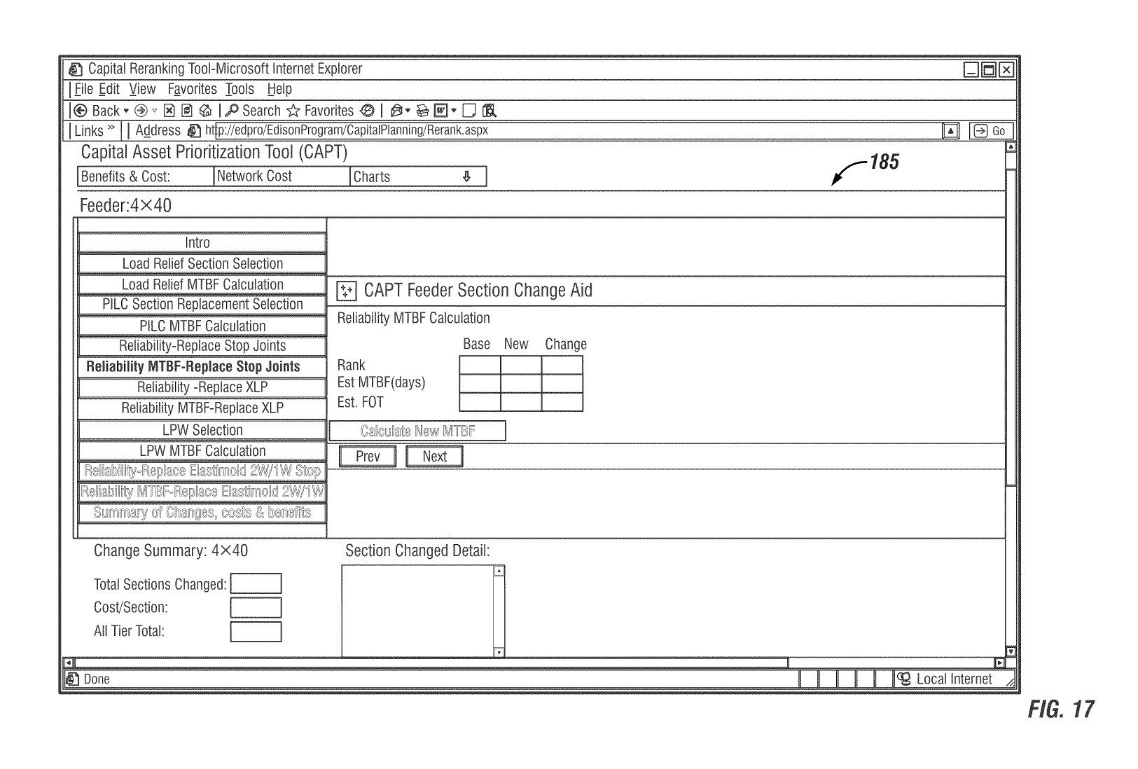

Further, FIGS. 16 through 21 illustrate additional improvement scenarios which may be selected by the user 1 via the GUI 60 shown in FIG. 1. FIG. 16 illustrates a screenshot 180 where the user 1 may selected an improvement scenario to replace stop joints without selected to replace specific segments of the feeder circuit. For example, the user 1 may desire to change 100% of the stop joints of a selected feeder circuit. Thus, the system 100 calculates cost based on the number of stop joints selected to be replaced by the user 1. FIG. 17 is a screenshot 185 illustrating the calculation of the MTBF based on the replacement of the stop joints as selected by the user 1 discussed above with respect to FIG. 16. In FIG. 17, the system 100 calculates the rank, the estimated MTBF and the estimated FOT based on the number of stop joints selected for replacement.

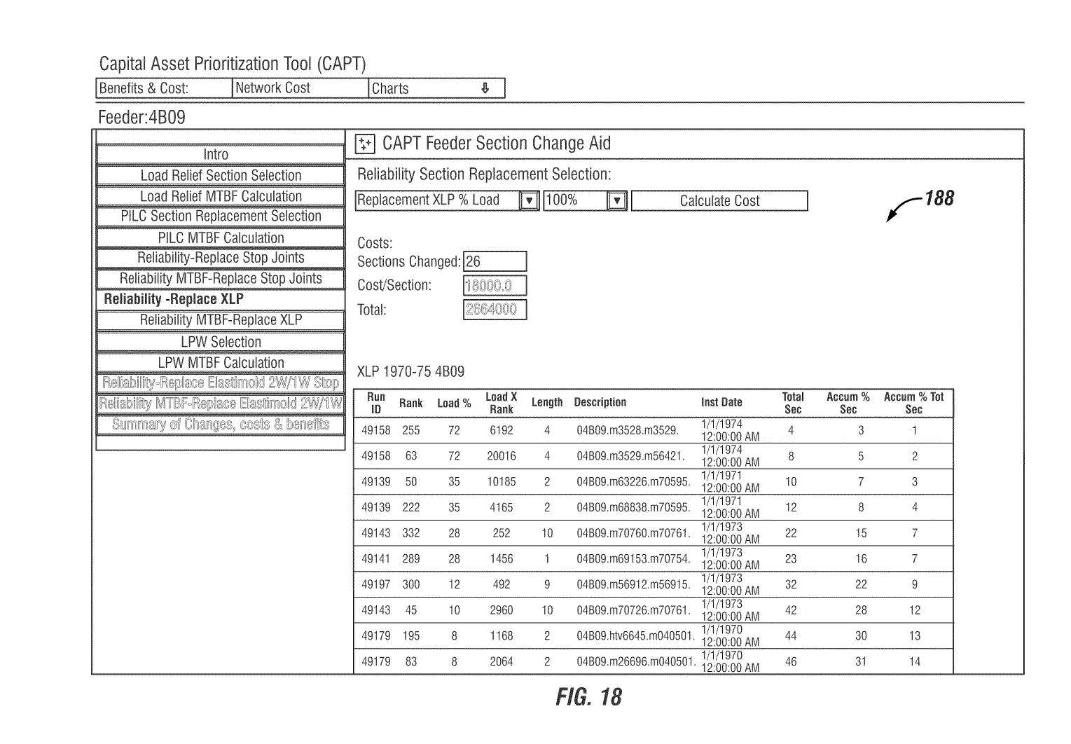

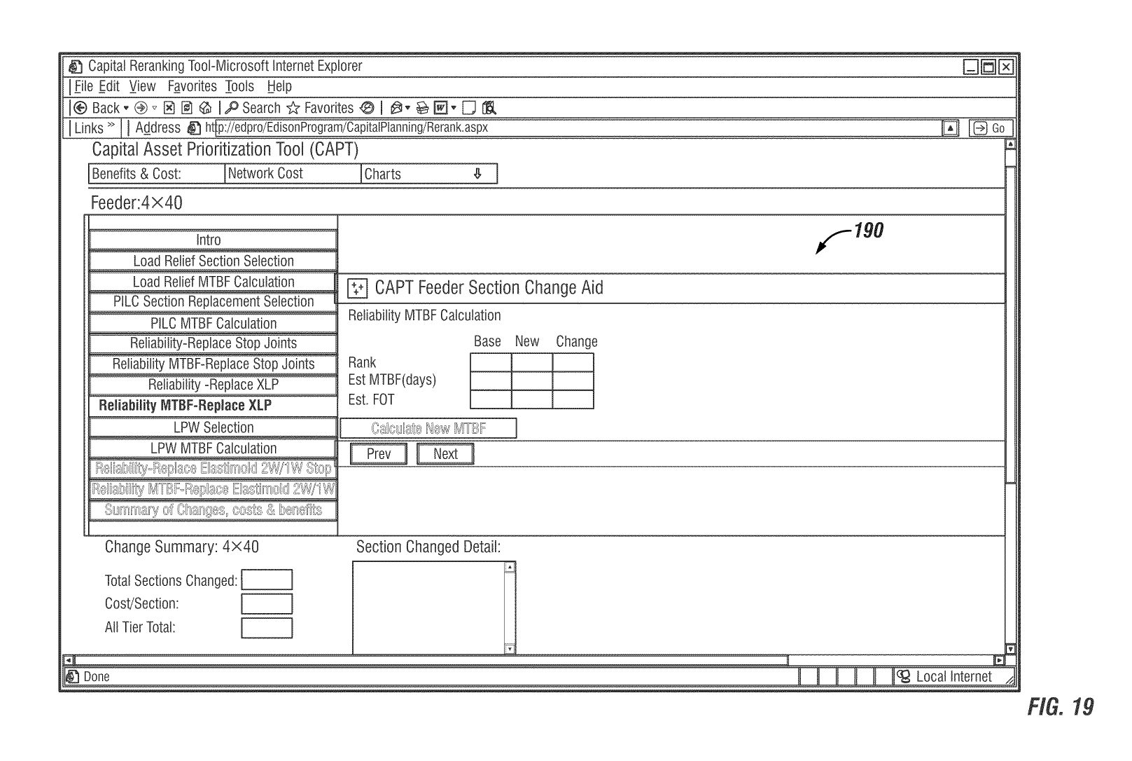

FIG. 18 is a screenshot 188 illustrating an improvement scenario that can be implemented within alternative embodiments of the present invention. As shown in FIG. 18, the user 1 may desire to replacement a percentage of XLP sections of the selected feeder circuit. For example, the user 1 may select to replace 100% f the XLP sections of the feeder circuit. If so, the system 100 provides the number of XLP sections to be changed and calculates associated cost, and provides a list of the XLP sections to be changed and associated information such as run ID and rank. FIG. 19 is a screenshot 190 illustrating the comparison information provided to the user 1 similar to that shown in FIGS. 11 and 15. However, the comparison information shown in FIG. 19 takes into consideration the replacement of XLP sections as selected by the user 1 discussed above with respect to FIG. 18.

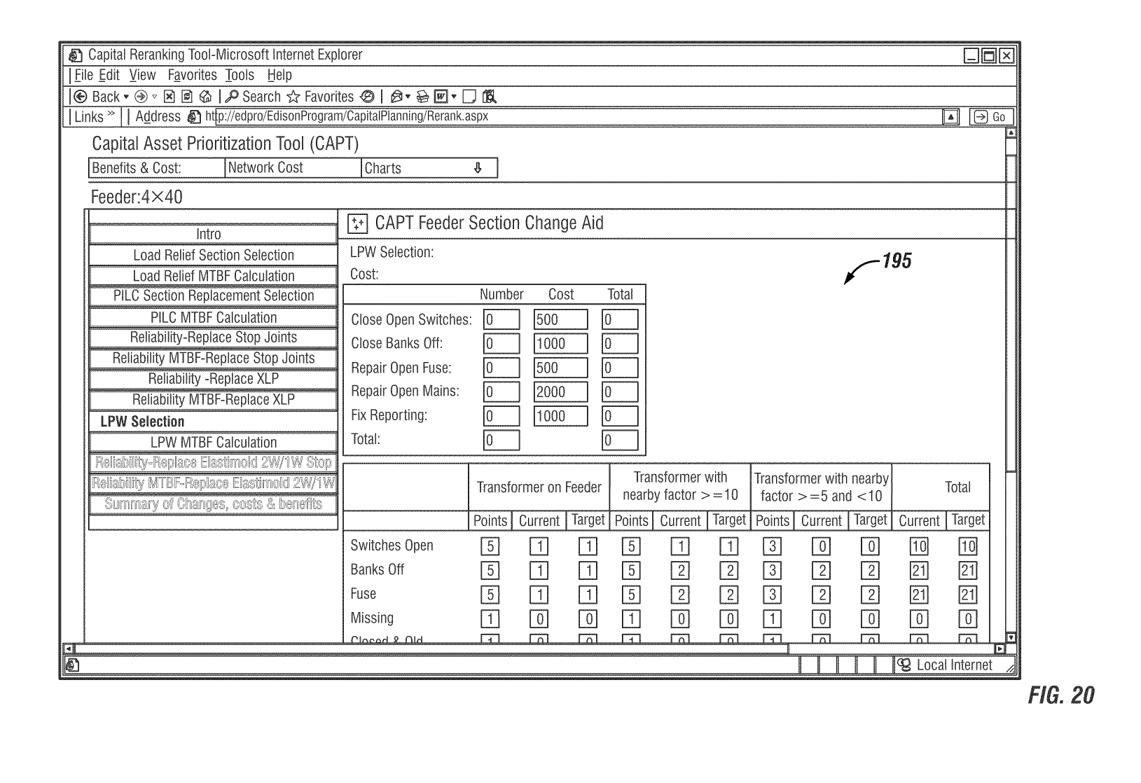

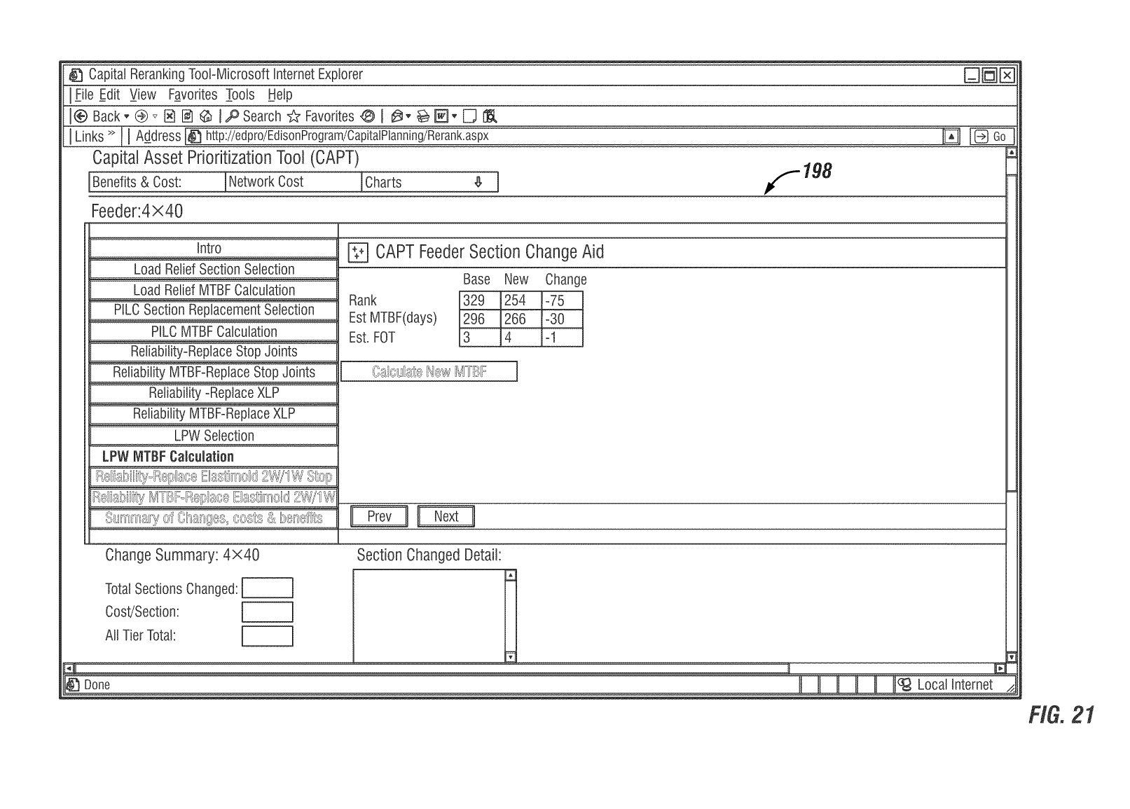

According to another embodiment of the present invention, the improvement scenarios may include an option to select load pocket weight (LPW) information as shown in FIG. 20. FIG. 20 is a screenshot 195 illustrating the LPW selection as an improvement scenario to be selected by the user 1 at the GUI 60. The LPW information is a calculation of the stress level of the electrical network. The user 1 may select to close specific open switches, close specific banks, repair open fuses or mains or fix reporting, for example. The system 100 then calculates cost based on the data input by the user 1. FIG. 21 is a screenshot 198 illustrating the comparison information provided to the user 1 similar to that shown in FIGS. 11, 15 and 18. However, the comparison information shown in FIG. 21 takes into consideration the LPW information as selected by the user 1 discussed above with respect to FIG. 20.

According to an embodiment of the present invention, the user 1 may select any single improvement scenario of the plurality of improvement scenarios or a combination of any of the improvement scenarios discussed above with reference to FIGS. 10 through 21, for example. The present invention is not limited to any particular improvement scenarios and may vary accordingly.

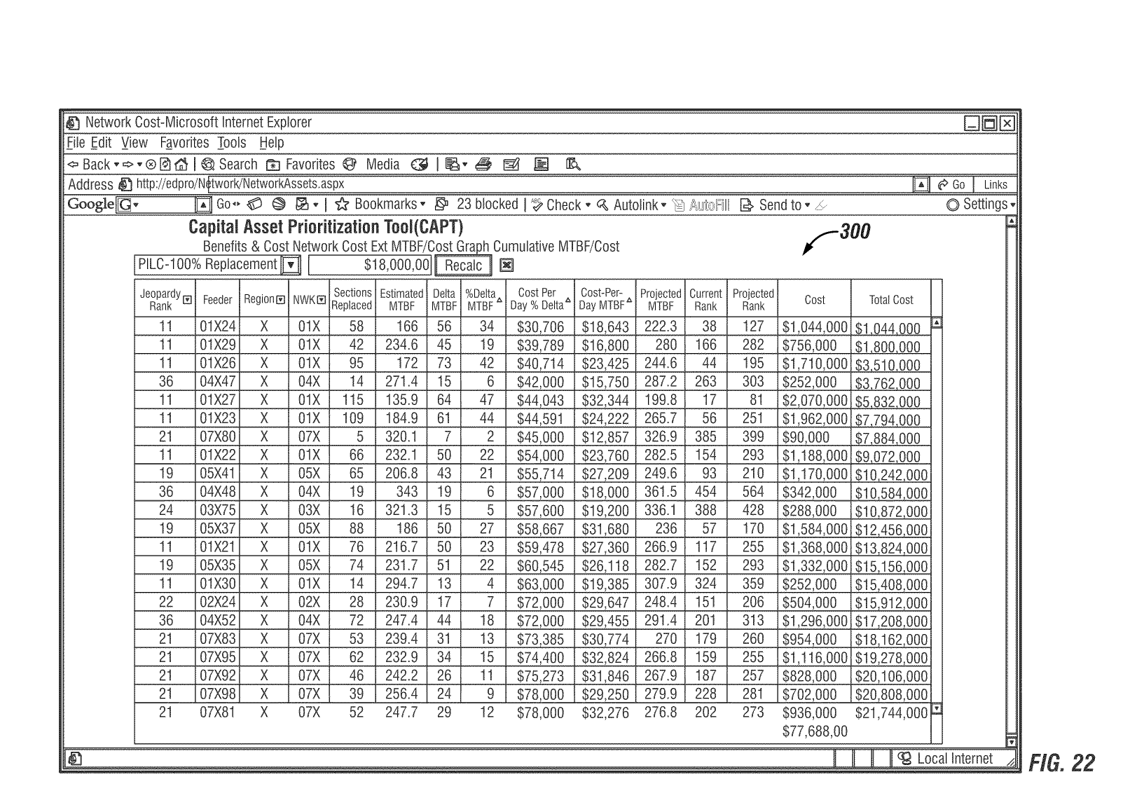

According to an embodiment of the present invention, capital asset allocation information corresponding to the selected utility service component and the comparison information is displayed to the user 1 via the GUI 60 in the form of a table or chart, for example, as shown in FIG. 22. The user 1 is able to review the information and select a suitable improvement scenario as desired. The information may be sorted in any way such as by the cost per day of increased MTBF. FIG. 22 is a chart 300 illustrating benefits and cost information associated with improvements to be made to specific electrical feeder circuits. The chart 300 provides ranking information, the feeder circuit, region, network, sections which have been replaced, estimated MTBF as calculated, delta MTBF, % MTBF, cost per day, cost-per-day MTBF, projected MTBF, current rank, projected rank based on improvement scenario to be selected, cost and total cost, for example. According to an embodiment of the present invention, the user 1 may first view the chart 300 shown in FIG. 22 to determine a desired feeder circuit to be analyzed.

Embodiments of the present invention provide an system and method for allocating capital assets for managing utility service components by simulating MTBF to compare improvement strategies for replacement of utility service components before investing money and time, and providing a standardized tool and audit trait for quantitative analysis, providing a quick study on new strategy and providing easily accessible data and visualization of utility service components replacement options.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A computer-implemented method of allocating capital assets for managing a plurality of utility service components, the method comprising:
ranking each of the utility service components based on data retrieved corresponding to the utility service components;
calculating a base failure metric for each of the utility service components;
receiving a selection of at least one utility service component of the plurality of utility service components inputted by a user;
analyzing the selected utility service component under a plurality of improvement scenarios;
calculating an estimated failure metric of the selected utility service component based on each of the improvement scenarios; and
displaying comparison information between the base failure metric and the estimated failure metric.

2. The computer-implemented method of claim 1, wherein the base failure metric is a mean-time-between-failure (MTBF) and the estimated failure metric is a cost per MTBF.

3. The computer-implemented method of claim 2, wherein ranking each of the utility service components and calculating the base failure metric are performed via a machine learning model.

4. The computer-implemented method of claim 3, wherein the data retrieved comprises at least one of past outage history, component characteristics, network configuration, electrical characteristics or environmental characteristics.

5. The computer-implemented method of claim 4, wherein the component characteristics comprises at least one of cable length, installation information, voltage information or electrical phase information.

6. The computer-implemented method of claim 2, wherein receiving a selection of at least one utility service component of the plurality of utility service components inputted by a user comprises:
displaying the plurality of utility service components in a graphical representation to be viewed by the user.

7. The computer-implemented method of claim 6, wherein a plurality of segments of each of the plurality of utility service components are represented by different colors on the graphical representation.

8. The computer-implemented method of claim 7, wherein a risk level of each of the segments of each of the plurality of utility service components are graphically displayed.

9. The computer-implemented method of claim 7, wherein the improvement scenarios comprise at least one of load relief, segment replacement and segment reliability.

10. The computer-implemented method of claim 9, wherein the utility service components are electrical feeder circuits and the plurality of segments are different types of cables and joints between each of the cables.

11. The computer-implemented method of claim 1, wherein analyzing the selected utility service component under a plurality of improvement scenarios comprises:
displaying the improvement scenarios for the selected utility service component, to the user;
receiving a selection of an improvement scenario from the user; and
calculating cost of improvement based on cost information input by the user.

12. The computer-implemented method of claim 11, further comprising:
receiving a selection of segments of the selected utility service component to be improved through an input by the user;

13. The computer-implemented method of claim 12, wherein the user selects the segments to be improved based on at least one of a target cost, percentage of segments to be improved, rank of the segment, load of the segment, or rank x load.

14. The computer-implemented method of claim 1, further comprising:
displaying capital asset allocation information corresponding to the selected utility service component and the comparison information.

15. A computer readable storage medium storing program instructions executable by a computer to perform a method of allocating capital assets for managing a plurality of utility service components, the method comprising:
ranking each of the utility service components based on data retrieved corresponding to the utility service components;
calculating a base failure metric for each of the utility service components;
receiving a selection of at least one utility service component of the plurality of utility service components inputted by a user;
analyzing the selected utility service component under a plurality of improvement scenarios;
calculating an estimated failure metric of the selected utility service component based on each of the improvement scenarios; and
displaying comparison information between the base failure metric and the estimated failure metric.

16. The computer readable storage medium of claim 15, wherein the base failure metric is a mean-time-between-failure (MTBF) and the estimated failure metric is a cost per MTBF.

17. The computer readable storage medium of claim 16, wherein ranking each of the utility service components and calculating the base failure metric are performed via a machine learning model.

18. The computer readable storage medium of claim 17, wherein the data retrieved comprises at least one of past outage history, component characteristics, network configuration, electrical characteristics or environmental characteristics.

19. The computer readable storage medium of claim 18, wherein the component characteristics comprises at least one of cable length, installation information, voltage information or electrical phase information.

20. The computer readable storage medium of claim 16, wherein receiving a selection of at least one utility service component of the plurality of utility service components inputted by a user comprises:
displaying the plurality of utility service components in a graphical representation to be viewed by the user.

21. The computer readable storage medium of claim 20, wherein a plurality of segments of each of the plurality of utility service components are represented by different colors on the graphical representation.

22. The computer readable storage medium of claim 21, wherein a risk level of each of the segments of each of the plurality of utility service components are graphically displayed.

23. The computer readable storage medium of claim 21, wherein the improvement scenarios comprise at least one of load relief, segment replacement and segment reliability.

24. The computer readable storage medium of claim 23, wherein the utility service components are electrical feeder circuits and the plurality of segments are different types of cables and joints between each of the cables.

25. The computer readable storage medium of claim 15, wherein analyzing the selected utility service component under a plurality of improvement scenarios comprises:
displaying the improvement scenarios for the selected utility service component, to the user;
receiving a selection of an improvement scenario from the user; and
calculating cost of improvement based on cost information input by the user.

26. The computer readable storage medium of claim 25, further comprising:
receiving a selection of segments of the selected utility service component to be improved through an input by the user.

27. The computer readable storage medium of claim 26, wherein the user selects the segments to be improved based on at least one of a target cost, percentage of segments to be improved, rank of the segment, load of the segment, or rank x load.

28. The computer readable storage medium of claim 15, further comprising:
displaying capital asset allocation information corresponding to the selected utility service component and the comparison information.

29. A system comprising:
a user interface configured to receive and transmit data to and from a user and a processing unit configured to:
receive ranking information corresponding to a plurality of utility service components based on data retrieved corresponding to the utility service components and a base failure metric for each of the utility service components,
receive a selection of at least one utility service component of the plurality of utility service components inputted by a user via the user interface,
analyze the selected utility service component under a plurality of improvement scenarios as selected by the user,
calculate an estimated failure metric of the selected utility service component based on each of the improvement scenarios, and
display via the user interface, comparison information between the base failure metric and the estimated failure metric to the user.

30. The system of claim 29, further comprising a visualization module configured to provide graphical mapping information of the utility service components to be displayed to the user via the user interface.

31. The system of claim 30, further comprising a re-ranking module configured to re-rank the utility service components based on an improvement scenario as selected by the user.

32. The system of claim 29, wherein a machine learning tool calculates ranking information corresponding to a plurality of utility service components based on data retrieved corresponding to the utility service components and the base failure metric for each of the utility service components and supplies the ranking information and the base failure metrics to the processing unit.
